(19) United States
(12) Patent Application Publication
(10) Pub. No.: US 2024/0392956 A1
(43) Pub. Date: Nov. 28, 2024

(54) LIGHTING DEVICE WITH ADJUSTABLE INCLINATION

(71) Applicant: Equilibrio, Munich (DE)

(72) Inventor: Albert R. JANSEN VAN ROSENDAAL, Western Cape (ZA)

(73) Assignee: Equilibrio, Munich (DE)

(21) Appl. No.: 18/694,407

(22) PCT Filed: Sep. 23, 2022
(86) PCT No.: PCT/EP2022/076550

§ 371 Date: Mar. 21, 2024

(30) Foreign Application Priority Data
Sep. 24, 2021 (DE) 10 2021 124 771.3

(51) Int. Cl. F21V 21/20; F21S 9/02; F21V 21/06; H02J 50/10

(52) U.S. Cl. CPC F21V 21/20; F21S 9/02; F21V 21/06; H02J 50/10

(57) ABSTRACT

A lighting device (100) with an adjustable inclination. The lighting device comprises a housing (10) with a convex foot section (11) and a shielding section (12) connected thereto. A weight (20) is fixed in the foot section (11) so as to have a variable position such that the center of mass of the lighting device (100) can be modified. The housing (10) is equipped with a lighting means (30) which is designed to emit light at least through the shielding section (12). The inclination of the lighting device (100) can be adjusted by changing the position of the weight (20) within the foot section (11).

### CROSS-REFERENCE TO RELATED APPLICATION

This application is a 371 application of the International PCT application serial no. PCT/EP2022/076550 filed on Sep. 23, 2022, which claims the priority benefit of German Patent Application No. DE 10 2021 124 771.3 filed on Sep. 24, 2021. The entirety of each of the above-mentioned patent applications is hereby incorporated by reference herein and made a part of this specification.

### BACKGROUND

### Technical Field

The disclosure relates to a lighting device with an adjustable inclination.

### Description of Related Art

Lighting devices are known from the related art, in particular, floor lamps, in which an upper part of the lighting device can be adjusted in inclination relative to a lower part of the lighting device by an articulated connection between the two.

### SUMMARY

Proceeding from the related art, the object of the disclosure is to provide a lighting device whose adjustability of inclination offers an improved degree of freedom.

The disclosure solves this problem with a lighting device according to claim 1. Accordingly, a lighting device with adjustable inclination is disclosed, which comprises a housing with a convex foot section and a shielding section connected thereto and a weight which is mounted in the foot section so that its position can be changed in such a manner that a centre of mass of the lighting device is variable. A light source can be arranged in the housing, which is configured to emit light at least through the shielding section. The inclination of the lighting device can be adjusted by changing a position of the weight within the foot section.

By changing the position of the weight in the foot section, the lighting device according to the disclosure therefore allows a change in the position of the centre of mass and thus in the static resting position of the lighting device. Accordingly, by changing the position of the weight, a change in the static resting position of the lighting device is possible, which, due to the convex shape of the foot section, leads to the lighting device inclining according to the changed position of the centre of mass, so that the lighting device adopts a new static resting position with a corresponding inclination of the lighting device. Accordingly, the inclination of the lighting device can be adjusted by changing the position of the weight, limited by the reaching of a precarious or unstable position.

Such a lighting device, in which only a part of the lighting device, for example, an upper part of the lighting device, can be changed in its inclination relative to another part of the lighting device, for example, a lower part of the lighting device, is not known from the related art. A change in the inclination of the lighting device—and thus the lighting device as a whole—is not possible with the lighting devices from the related art. In other words, known lighting devices only allow adjustment of the inclination of a part of the lighting device and not of the lighting device per se.

According to the disclosure, the shielding section can comprise substantially any shape, as a result of which the lighting device can be configured in a particularly versatile manner. The shielding section can advantageously be configured to be translucent or partially transparent, up to and including fully transparent, in order to enable light to be emitted through the shielding section. However, the shielding section can also be made of an opaque material, which allows light to be emitted through recesses, such as perforations. The shielding section can preferably consist of a synthetic material such as resin, in particular, polycarbonate, which can, for example, be diffusely refractive. However, the shielding section can also consist of glass, ceramics and the like. The shielding section can be manufactured particularly advantageously by injection moulding.

According to the disclosure, what has been said above applies analogously to the foot section, which can also be designed to be translucent or partially transparent, up to and including fully transparent, or opaque.

The upper and lower parts are preferably made from the same material and are translucent.

In principle, all suitable light sources can be considered as light sources, such as LED light sources, including flat lighting panels and/or LED retrofit units, fluorescent tubes, conventional light bulbs and the like. The light source can be supplied with current by means of a power cable routed out of the lighting device and/or can comprise a rechargeable battery in order to be operated (at least temporarily) without an external power supply. The lighting device can also be provided with electronic controls to be controlled by a remote-control means. This includes both dedicated hardware devices (remote control in the narrower sense) and multifunctional devices equipped with the appropriate software, such as computers, smartphones, tablets and the like. Alternatively, or additionally, a control interface, such as a touchscreen and buttons on the lighting device itself or on the power cable, if present, can also be provided. It is therefore advantageously possible to control the parameters of the light output of the lighting device as desired. This includes, for example, the control of lighting colour (i.e. preferably control of the RGB light components) and/or colour temperature and/or light intensity. For example, the use of a lighting device provided with RGB light-emitting diodes is possible.

According to the disclosure, the term “convex” is interpreted broadly and refers to all surfaces which are curved outwards (relative to the foot section). The surface does not necessarily have to be rotationally symmetrical.

In the context of the disclosure, it is also preferable to limit the degree of positional variability of the weight in such a way that at a maximum positional change, the lighting device does not adopt (approach) a precarious or unstable position, so that the lighting device is prevented from tipping over. This can be achieved by appropriate static design of the centre of mass of the lighting device, and by considering the mass of the weight through calculation or experimental analysis.

To increase the stability of the lighting device, it is also advantageous to place the foot section of the lighting device on a retaining ring resting on the actual installation site. This can be made of transparent silicone, for example. Retaining rings made of wood, ceramic or metal or other materials are also suitable.

Preferred embodiments of the disclosure are specified in the dependent claims and are also derivable from the description, the Figs. and the description of the Figs.

It is advantageous to attach the weight to a spindle which is mounted in the foot section on bearing points, so that it can be rotated in a displaceable manner about a spindle axis.

A weight which is variable in position according to this embodiment is particularly easy to handle, because changing the position only requires a rotation of the spindle about its spindle axis, as a result of which the weight can be displaced along the spindle axis according to the pitch of the spindle. Substantially, only a transverse force acts on the spindle, which means that the spindle and bearing points are subject to low stress.

Alternatively, it would also be conceivable, for example, to connect the weight rigidly to an axle mounted on the bearing points instead of the spindle, wherein a change in the position of the weight is achieved by rotating the axle and fixing the rotational position of the axle in this other position. The weight would then be variable in position in the circumferential direction about the axle over a segment of an arc. Although this simplifies manufacture compared to the manufacture of a spindle and attachment of the latter to a spindle axis, it leads to torsional stress on the axle and higher bending moments at the bearing points.

It is advantageous to define an adjustment range in the direction of the longitudinal extension of the spindle, within which the weight is attached to the spindle in a displaceable manner, and for the adjustment range to be shorter than a distance between the bearing points.

This ensures that the position of the weight can only be changed within the predetermined adjustment range. In this manner, on the one hand, the maximum inclination of the lighting device can be limited, preferably to allow only statically stable positions of the lighting device. On the other hand, it is also reliably possible to prevent the weight from contacting the foot section thereby counteracting any damage to the same, and—in the case of a translucent foot section—preventing disadvantageous shadows from being cast by the weight.

It is advantageous that the lighting device comprises a foot weight arranged in a lower part of the foot section and rigidly connected thereto, which is configured to change a position of the centre of mass of the lighting device in the direction of a longitudinal axis of the foot section. This increases the stability of the lighting device in the inclined state by always ensuring a restoring torque. This is particularly advantageous for especially tall lighting devices, which would cause an unfavourable displacement of the centre of mass of the lighting device, e.g. with very long upper parts.

“In the direction of a longitudinal axis” means both along the direction of the longitudinal axis and from a position laterally alongside the longitudinal axis further towards the longitudinal axis.

A particularly dense material, such as a metal, is preferred for the foot weight to achieve high mass with low volume. In the case of a (partially) transparent foot section, a foot weight which can be provided in such a compact manner influences the light emission as little as possible. Alternatively, or additionally, the foot weight can be configured, for example, in the shape of a cone or a truncated cone. Alternatively, or additionally, the foot weight can be provided with a (possibly diffuse) reflecting surface. The weight is particularly preferably configured as an energy-storage device, so that the lighting device can be configured to be 10 wireless. For this purpose, an inductive charging option is preferably provided, in which the corresponding conductor loop for transmitting electrical energy is arranged in the foot part and is connected to the energy-storage device via an electronic charging circuit. The shape is preferably similar to an inverted pyramid, truncated cone or cone, thereby providing benefits in terms of shadowing. The corresponding external charging device for generating the inductive energy transfer ideally comprises a concave region into which the base of the lighting device can be placed in order to charge it. Such concave bearing points can also be integrated, for example, into items of furniture, which then increases the friction at the same time, and the lighting device receives an even more secure footing.

It is advantageous if the convex foot section is partially ellipsoidal, preferably semi-ellipsoidal and, by particular preference, hemispherical.

As previously mentioned, all that is required is that the foot section be convex. This includes a particularly wide variety of shapes for the foot section. A hemispherical foot section is particularly advantageous, since this is particularly easy to manufacture and is aesthetically pleasing due to its rotationally symmetrical shape.

It is advantageous if the spindle extends parallel to a main axis or a secondary axis of the part-ellipsoidal or semi-ellipsoidal foot section, particularly in the case of a hemispherical foot section, parallel to a diameter of the hemispherical foot section.

This allows a kinetically particularly uniform adjustability of the inclination of the lighting device since the change in the centre of mass to be achieved by the weight in this case—starting from a neutral position of the lighting device—causes the same amount of change in both possible directions of adjustment. The handling of the lighting device can thus be improved.

It is advantageous if the shielding section and the foot section can be connected in a releasable manner in a plurality of orientations relative to one another, the orientations differing in terms of an angle of rotation about an axis of rotation which extends through a centre point of a base area of the shielding section.

This allows the lighting device to be configured with a particularly high degree of freedom. In addition to adjusting the inclination of the lighting device, a user can therefore also change the outer shape of the lighting device in as many ways as possible by changing the relative orientations of the shielding section and the foot section. This adjustability is particularly effective when using a non-rotationally symmetrical shielding section.

It is advantageous if the orientations about the axis of rotation can be selected continuously, or (i.e. alternatively) if the orientations about the axis of rotation can be selected discontinuously and can advantageously be selected at angular differences spaced evenly from each other about the axis of rotation.

This allows the lighting device to be optimally adapted to the user's needs. If the user desires maximum adjustability of the lighting device, the lighting device can be configured so that the orientations can be selected continuously. If only certain orientations are to be made possible, the lighting device can be configured in such a manner that the orientations can only be selected discontinuously. The latter case may be desirable, for example, when a number of lighting devices are to be used at one installation location and a uniform appearance is to be configurable.

It is advantageous if the shielding section and the foot section are each attached to a connecting ring, in the inner area of which a holder for the light source is arranged.

This simplifies the construction of the lighting device in that the shielding section and foot section can be manufactured as physically separate components and can ultimately be connected via the connecting ring. At the same time, the assembly of the electronic components and the spindle with the weight is made easier, and the transportability of the lighting device is improved if the lighting device can be transported dismantled into the parts named.

If the shielding section is rotatable about the axis of rotation, the connecting ring can comprise a corresponding mechanical interface which allows rotatability. This can be, for example, an annular groove running around (at least partially) in the circumferential direction of the connecting ring, in which the shielding section engages and in which it can be (detachably) fastened, for example, by clamping or by screwing. The shielding section can also conceivably be provided with magnets (countersunk into the shielding section itself), preferably at its end engaging in the connecting ring, which can interact with corresponding magnets of the connecting ring or with a magnetic annular groove of the connecting ring. A discontinuous selection of orientations can be achieved, for example, if the shielding section and the connecting ring or its annular groove can only be mechanically connected in predetermined orientations, for example, by means of a tongue and groove pairing or by using a bayonet fastening.

According to one preferred embodiment, the position of the lighting device can be adjusted by changing the position of the weight using a drive device. The drive device includes at least one motor which changes the position of the weight. The drive device can also include other auxiliary means, for example, various belt drives which cooperate to change the position of the weight.

Furthermore, it is advantageous if a pendulum, which comprises an antenna for the transmission of energy for the inductive charging of an energy-storage device, is provided in the foot section of the lighting device. This pendulum advantageously penetrates the foot weight of the lighting device, which simultaneously forms the energy-storage device, so that the antenna of the pendulum comprises the smallest possible distance from the antenna provided outside the lighting device in order to enable efficient inductive charging.

### BRIEF DESCRIPTION OF THE DRAWINGS

These and other advantages are also derivable from the Figs. described below. The drawings show:

FIG. 1a shows a foot section according to an embodiment of the present disclosure,

FIG. 1b shows the foot section according to FIG. 1a with a different inclination,

FIG. 2a shows a lighting device according to an embodiment of the present disclosure with the shielding section detached,

FIG. 2b shows the lighting device according to FIG. 2a with connected shielding section,

FIG. 3 shows a lighting device according to an embodiment of the present disclosure with a detached shielding section.

FIG. 4 shows a connection ring according to an embodiment of the present disclosure,

FIG. 5 shows a view of a second exemplary embodiment with a weight which can be moved by a motor in a first position,

FIG. 6 shows a second position of the weight and the lighting device of the second exemplary embodiment,

FIG. 7 shows a view of the lighting device rotated by 90° about the axis of rotation according to the second exemplary embodiment, and

FIG. 8 shows an enlarged view of part of the second embodiment.

### DESCRIPTION OF THE EMBODIMENTS

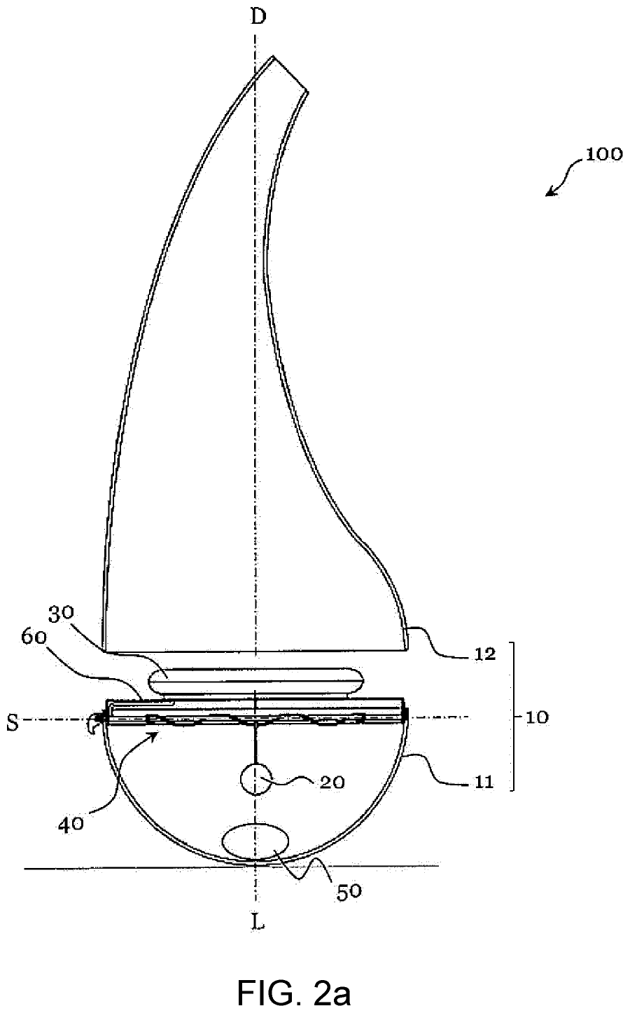

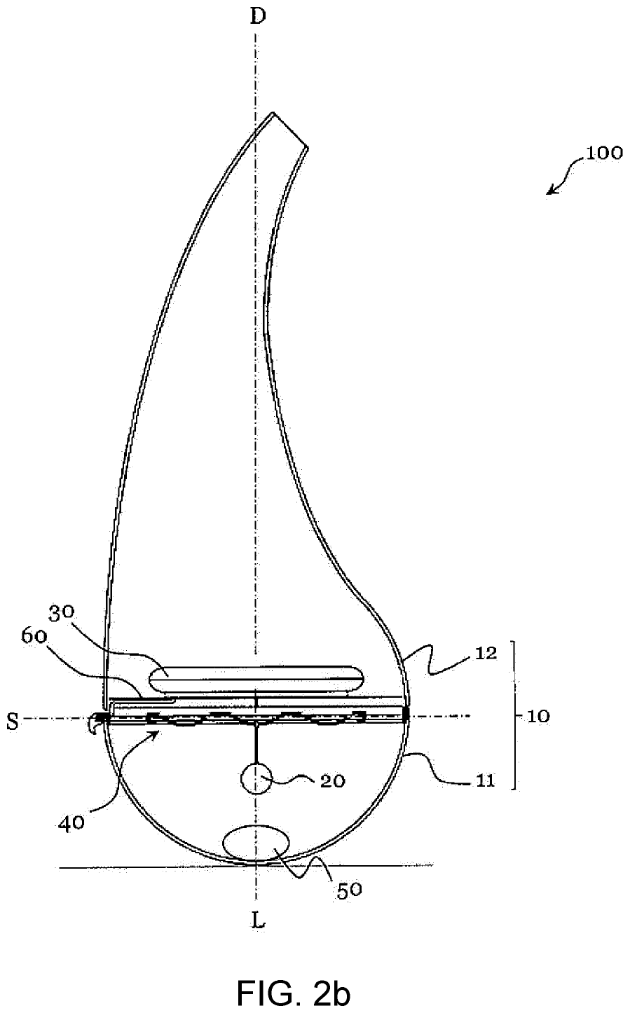

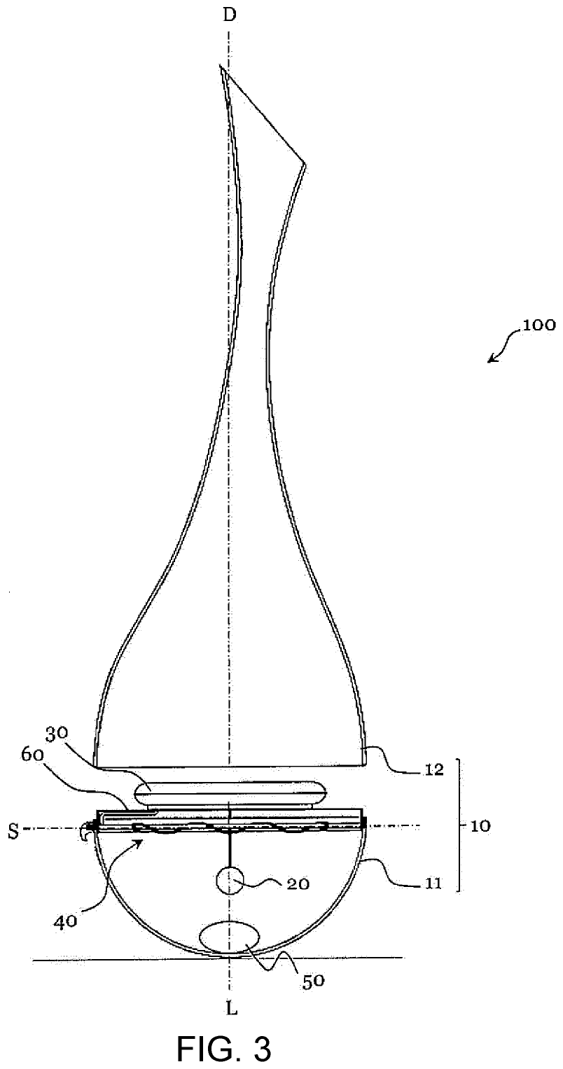

Lighting devices with adjustable inclination 100 according to the present disclosure are shown in FIGS. 2a, 2b and 3. As can be seen in the Figs., each of the lighting devices 100 according to the disclosure comprises a housing 10 with a convex foot section 11 and a shielding section 12 detachably connected thereto. As shown by way of example in FIGS. 2a. 2b and 3, the shape of the shielding section 12 can be any shape desired, which allows the lighting device 100 to be configured in a particularly versatile manner.

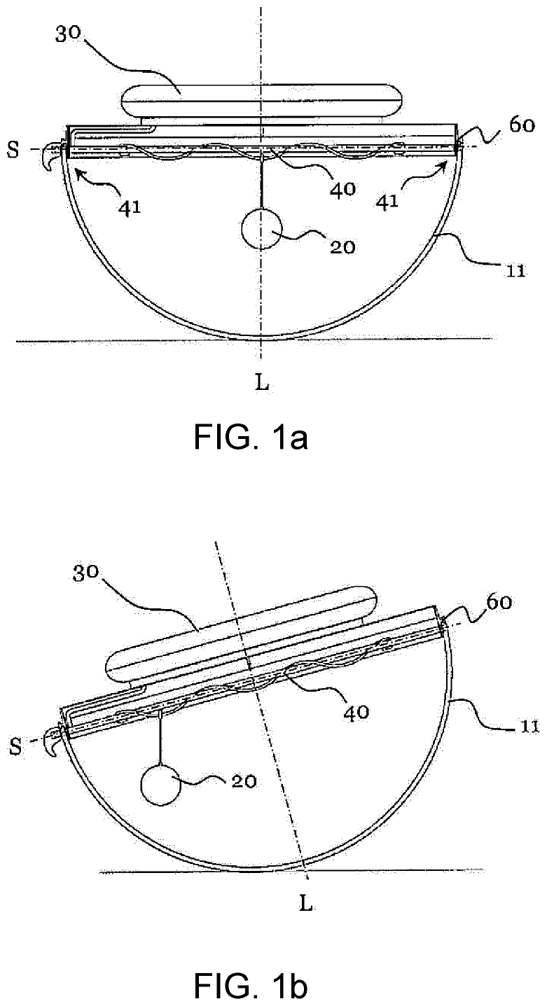

Furthermore, the lighting device 100 comprises a weight 20, which is attached in the foot section in such a manner that its position can be varied, so that a centre of mass of the entire lighting device 100 is variable. In the embodiments shown in FIGS. 1a, 1b, 2a, 2b and 3, the weight 20 can be substantially spherical and can be suspended in the manner of a pendulum from a spindle 40.

A light source 30 is arranged in the housing 10 and is configured to emit light at least through the shielding section 12. The light source 30 is preferably also configured to emit light through the foot section 11. The light source 30 can be a flat lighting panel 30, for example, which allows (remote) control, for example, of colour temperature and/or lighting colour and/or light intensity by means of preferably integrated electronic controls. An LED retrofit unit can also be provided instead of the flat lighting panel or in addition thereto.

The inclination of the lighting device 100 can be adjusted by changing a position of the weight 20 within the foot section 11, as shown in FIGS. 1a and 1b. For this purpose, it is advantageous if the weight 20 is fastened to a spindle 40 which is mounted in a displaceable manner in the foot section 11 at bearing points 41 such that it can be rotated about a spindle axis(S).

In the illustrated embodiments, it is advantageous that a longitudinal extension of the spiral of the spindle 40 defines an adjustment range, within which the weight 20 is mounted displaceably along the spindle 40, and that the adjustment range is shorter than a distance between the bearing points 41. This is shown particularly clearly in FIGS. 1a and 1b. To limit the adjustment range, the spiral of the spindle 40 can be connected at its ends to a shaft which carries the spiral. The spindle 40 is held by the shaft, which is mounted rotatably in the foot section 11 at the bearing points. The weight 20 can preferably comprise a closed eyelet which runs on the spiral, as a result of which the weight 20 can be attached to the spindle 40 in a captive and displaceable manner. The spindle 40 is operable by an outwardly protruding handle. Additionally, or alternatively, the spindle 40 can also be actuated by a (remotely) controllable actuator such as a motor.

As shown in FIGS. 2a and 2b, the lighting device 100 preferably comprises a foot weight 50 arranged in a lower part of the foot section 11 and rigidly connected thereto. The foot weight 50 can be configured to influence a position of the centre of mass of the lighting device 100 in the direction of a longitudinal axis (L) of the foot section 11, especially ensuring a self-righting torque in all positions. In the examples shown in FIGS. 1a, 1b, 2a, 2b and 3, the convex foot section 11 can be partially ellipsoidal, preferably semi-ellipsoidal and by particular preference hemispherical.

It is evident from the Figs., in particular FIGS. 1a and 1b, that the spindle 40 can extend parallel to a main axis or a secondary axis of the partially ellipsoidal or semi-ellipsoidal foot section 11, specifically, in the case of the hemispherical foot section 11, it can extend parallel to a diameter of the hemispherical foot section 11. In the example, this is achieved by arranging the spindle 40 horizontally in relation to the neutral inclination 100 of the foot section 11 in FIG. 1a.

It is advantageous and particularly clear in the example of FIGS. 2a, 2b and 3 that the shielding section 12 and the foot section 11 can be connected in a manner releasable in several orientations, wherein the orientations differ in terms of an angle of rotation about an axis of rotation (D) passing through a centre of a base area of the shielding section 12. For this purpose, the shielding section 12 can be detachable from the foot section 11, as shown, and can thus be reconnected to the foot section 11 in a different orientation. The lighting device 100 can thus be configured in a particularly variable manner.

The orientations about the axis of rotation (D) can preferably be selected continuously or discontinuously and can preferably be selected with angular differences about the axis of rotation (D) which are spaced evenly apart from one another.

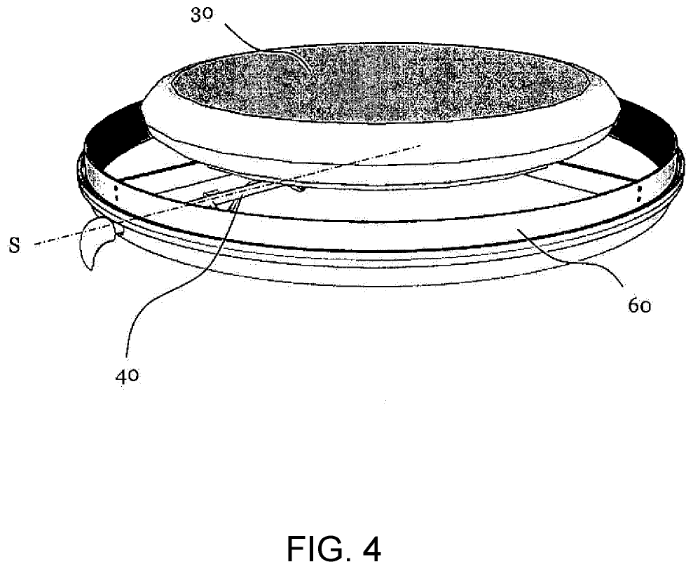

In all the illustrated embodiments of FIGS. 1a to 4, the shielding section 12 and the foot section 11 are preferably each attached to a connecting ring 60, in the interior of which a holder for the light source 30 can be arranged. An example of the connecting ring 60 can be seen particularly well in FIG. 4. Following this, a preferably circumferential cylindrical wall, which can extend in the assembled condition in the direction of the longitudinal axis (L) of the foot section 11, can enclose the connecting ring 60. A T-shaped projection can be arranged protruding from the cylinder wall, which can thus form two annular grooves in which the shielding section 12 and the foot section 11 can engage (preferably in a releasable manner) in order to be connected to one another. The shielding section 12 and the foot section 11 can each be attached to the connecting ring 60 in a variety of ways, for example, by means of a bayonet fastening. The connecting ring 60 is advantageously made of aluminium. The holder for the light source 30 can be configured through the formation of a projection directed inwardly relative to the connecting ring 60, which preferably also allows an emission of light from the light source 30 through the foot section 11.

The advantages of features and combinations of several features named in the description are merely exemplary and can act in alternation or cumulatively without these advantages necessarily having to be achieved by embodiments according to the disclosure.

The following points apply with regard to the disclosure content of the present documents: Further features can be derived from the drawings—in particular, the illustrated geometries and the dimensions of several components relative to one another as well as their relative arrangement and operative connection. The combination of features of different embodiments of the disclosure or of features of different patent claims is also possible, by way of deviation from the selected interdependencies of the patent claims, and is hereby also encouraged. This also applies to those features shown in separate drawings or named in their description. These features can also be combined with features of different patent claims. Likewise, features listed in the patent claims can be omitted for further embodiments of the disclosure, although this does not apply to the independent claims of the granted patent.

Regarding their number, the features named in the patent claims and the description are to be understood in such a way that exactly this number or a larger number than the number named is present without the need for an explicit use of the adverb “at least”. So, for example, if an element is named, this is to be understood in such a manner that exactly one element, two elements or more elements are present. These features may be complemented by other features, or they may be the only features that make up the product in question.

The reference numbers contained in the claims do not limit the scope of the subject-matter protected by the claims. They only serve the purpose of making the claims easier to understand.

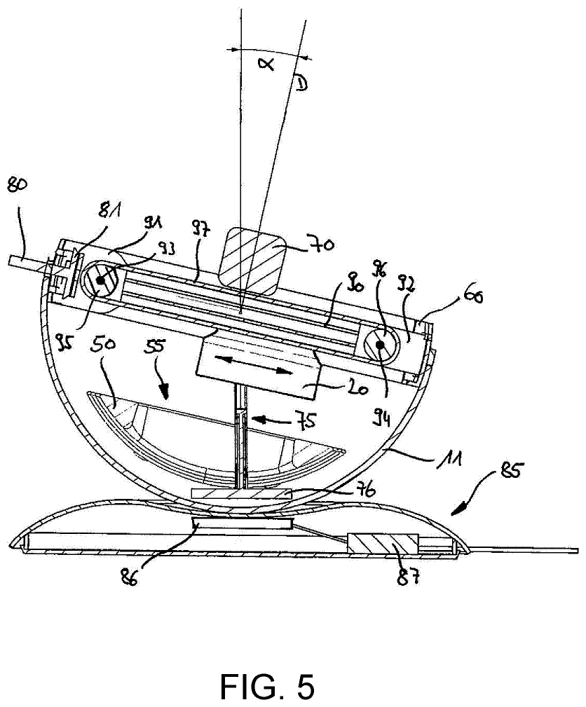

According to the embodiment described above, a manual operation is provided to change the position of the weight 20, according to which, using an externally accessible element, the spindle 40 is rotated inside the foot section 11, thereby causing a linear change in the suspension point of the weight 20. As an alternative, provision can also be made for the weight 20 to be displaced inside the foot section 11 with the aid of a drive device, for example an electric motor. Such a second embodiment is described below with reference to FIGS. 5 to 8.

The substantial elements are explained initially with reference to FIG. 5. The elements not described below correspond to those already described or have been modified by a skilled person. This applies specifically to the connection of the shielding section 12.

In the second exemplary embodiment shown, an aluminium profile 90 is arranged in the foot section 11 and is locked at its two opposite ends in the longitudinal direction by a first holder 91 and a second holder 92 onto the foot section 11. For this purpose, the two holders 91 and 92 can be fastened to the connecting ring 60 on opposite sides, for example. The two holders 91 and 92 hold the aluminium profile 90, which at the same time, through its longitudinal extension, defines the direction of movement of the weight 20.

A shaft or axle 93 or 94 is arranged on the holders 91 and 92 and carries a drive wheel 95 or a driven wheel 96, respectively. A revolving continuous belt 97 is arranged on the drive wheel 95 and the driven wheel 96. This continuous belt 97 is driven using a motor 70 as the driving device, the control of the motor 70 (not shown in the figure) being configured in such a manner that the continuous belt 97 can be moved both clockwise and counter clockwise with respect to the view in the FIG. It should be noted that choosing an aluminium profile 90 has technical advantages. However, another connection between the two holders is also conceivable, which has a linear extension and is suitable for fastening the motor 70 and the pendulum, which will be explained in greater detail below, and for embodying a rail for the weight 20.

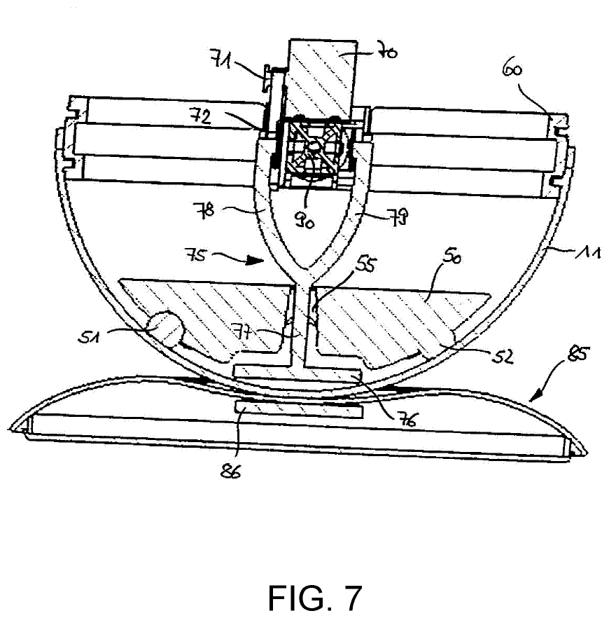

According to one preferred embodiment, a manual actuation can also be provided in the second embodiment, which can be operated by means of an actuation element 80 protruding outwards from the foot section 11. This actuating element 80 cooperates with a bevel gear 81, which engages with a further bevel gear, not shown in the Fig., which is rigidly connected to the drive wheel 95. The additional bevel gear, not shown, serves at the same time as a belt pulley to cooperate with the motor 70 via an additional drive belt. Depending on the direction of rotation of the actuating element 80, a rotation is thus achieved in a clockwise or counter-clockwise direction. The driven pulley of the motor 70 is described below with reference to FIG. 7. The weight 20 is connected rigidly to the continuous belt 97, so that it follows a movement of the continuous belt 97. As shown in FIG. 5, this allows the weight 20 to be displaced in the direction indicated by the double-headed arrow. The position of the weight 20 is thus changed by the motor 70 as the drive device in such a manner that the entire centre of mass of the lighting device or of the foot section 11 can be adjusted. The motor 70 is preferably controlled by a controller which can be operated remotely by an external control device (for example a smartphone on which an app is installed).

It has already been explained with reference to the first exemplary embodiment that the foot weight 50 can simultaneously serve as an energy-storage device for supplying the lighting device 100. In the present case, in the second exemplary embodiment shown, it is advantageous if the power supply for the motor 70 is also derived from the foot weight 50. In the second exemplary embodiment, an inductive charging device 85 is provided for recharging the energy-storage device. The inductive charging device 85 preferably also serves as the base of the lighting device 100. For this purpose, the part of the housing of the charging device 85 facing the lighting device 100 preferably comprises a concave central area on which the convexly configured foot section 11 can be positioned.

The actual electronic charging circuit 87 is arranged inside the housing of the charging device 85 and connected to a first antenna 86 for wireless transmission of energy to the lighting device 100. This first antenna 86 is arranged in the middle, concave area of the charging device 85. The first antenna 86 cooperates with a second antenna 76 which is arranged inside the foot section 11.

This charging technology itself is known from various fields, for example, the induction charging of mobile phones, tablets, electrical hand tools or similar devices, and can be adapted to the desired or required energy requirements of the lighting device and the drive technology.

While it can be provided, in one particularly simple exemplary embodiment, that the second antenna 76 is in a fixed position in the foot section 11, it is advantageous if the second antenna 76 moves dependent upon the inclination of the foot section 11 in such a way that, independently of the set inclination of the lighting device 100, it is disposed opposite to the first antenna 86. According to the preferred embodiment, this is achieved in that the second antenna 76 in the foot section 11 is part of a pendulum 75 which is suspended in such a manner that the second antenna 76 is always at the lowest point of the foot section 11 due to gravity and thus at a short distance from the first antenna 75 when the lighting device 100 is positioned on the charger. Because of the wireless energy supply, the operation, including the motorized position change, a free positioning of the lighting device 100 is possible when the energy-storage device is sufficiently charged. Control of the centre of mass with the adjustable position of the weight, together with the dome-shaped foot section, means that the lighting device returns to the desired position, even if it has been knocked out of position, for example, by accident.

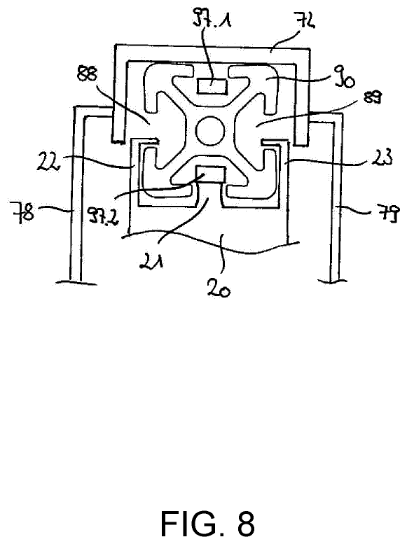

The pendulum 75 is formed in the foot section 11 with one end of the pendulum 75 being formed by the second antenna 76. The pendulum 75 is suspended rotatably but in a fixed position at its end facing away from the second antenna 76. The axis of rotation is perpendicular to the direction of movement of the weight 20. The precise configuration of this suspension is explained below with reference to FIG. 8. The pendulum 75 is preferably constructed so that it does not impede the movement of the weight 20 and does not therefore limit the maximum adjustment of the inclination of the lighting device 100. This is also explained in greater detail below with reference to FIGS. 7 and 8.

It should be noted that the weight 20 can be moved in both directions along the aluminium profile 90 starting from a central position which is in the geometric centre of the longitudinal extension between the first holder 91 and the second holder 92. A deflection of the foot section 11 (and thus an inclination of the entire lighting device 100) is thus possible in both directions. The longitudinal extension and the direction of movement, as well as the axis of rotation D already described above, lie in the plane of inclination, while the axis of the pendulum 75 runs perpendicular thereto. In the neutral position of the foot section 11, the axis of rotation D coincides with the vertical. Ideally, the masses of the other components arranged in the foot section 11 are also balanced in such a way that the overall centre of mass coincides with a middle position of the weight 20. Any asymmetry of the maximum inclinations of the entire lighting device 100 thus results only from the asymmetrical mass distribution of the shielding section 12.

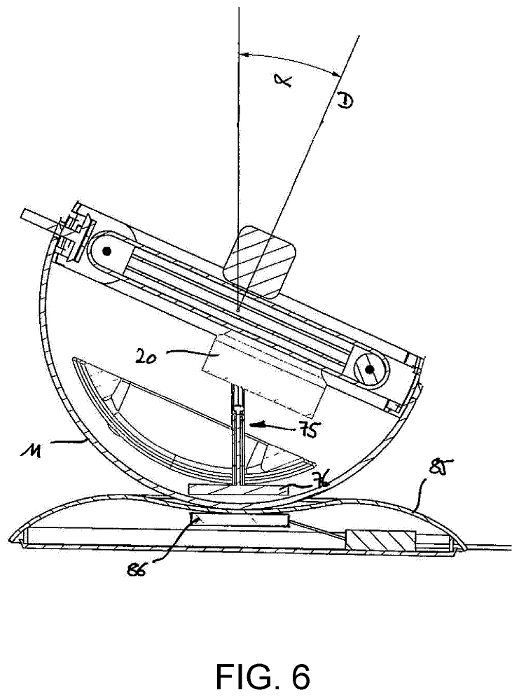

FIG. 6 shows a second deflection of the foot section 11. In this case, the angle α′ between the vertical and the axis of rotation D is enlarged by comparison with the angle α in the illustration in FIG. 5. This is achieved by the weight 20 being deflected further in the direction of its one end position at the second holder 92. As already explained, this is achieved with the help of the motor 70 and a first belt drive, which acts on the drive wheel 95, which moves the continuous belt 97 in such a manner that the weight 20 coupled thereto is further displaced from its centre position. As a reaction, the rotational axis D is inclined further relative to the vertical. A reverse direction of movement then straightens the lighting device 100 up again, and if the weight 20 is displaced further, the lighting device 100 is inclined in the other direction.

In the illustrated embodiment, no specific bearing is provided between the foot section 11 and the charging device 85. The lighting device 100, or more precisely the foot section 11, is placed directly on the housing in its concave area. To allow the foot section 11 or the entire lighting device 100 to be inclined more easily, for example, ball-bearing elements can be provided in the charging device 85 for the mounting of the lighting device 100, which achieve a reduction in friction for easier movement of the foot section 11. Effects such as an oscillation can thus be achieved without great expenditure of energy through a regular, reciprocating displacement of the weight 20.

It is clearly evident from FIGS. 5 and 6 that the second antenna 76, which is attached to the pendulum 75, does not change its position relative to the first antenna 86 of the charging device 85 because of the force of gravity. This ensures that a good energy transfer between the charging device 85 and the energy-storage device of the lighting device 100 is always guaranteed, regardless of the set inclination of the lighting device 100.

FIG. 7 shows a 90° rotated sectional view of the foot section 11 positioned on the charging device 85, in which the weight has been omitted for reasons of visual clarity. It is evident that a shaft 71 protrudes laterally from the motor 70, over which a drive belt of the belt drive runs, which cooperates with the pulley connected to the drive wheel 75 (not visible in the figure) and thus causes the movement of the continuous belt 97.

In the exemplary embodiment shown, the motor 70 is fixed on the aluminium profile 90, with a retaining mount 72 being additionally provided between the motor 70 and in the aluminium profile 90, which serves for the rotatable mounting of the pendulum 75. The pendulum 75, in turn, comprises a first leg 78 and a second leg 79 at its end facing away from the second antenna 76. The two legs 78 and 79 are spaced apart from one another transversely to the longitudinal extension of the aluminium profile 90 in such a manner that the weight 20 (not shown in FIG. 7) can pass between the legs 78 and 79. Accordingly, a central arrangement of the pendulum 75 with respect to the direction of movement of the weight 20 is possible, wherein the movement of the weight 20 is still not prevented by the pendulum 75.

In the cross-sectional view of FIG. 7, it can also be clearly seen that the foot weight 50 comprises a slot 55 through which a connecting section 77 of the pendulum 75 extends. The connecting section 77 connects the point at which the first leg 78 and the second leg 79 merge to the second antenna 76. Furthermore, it is evident that, in the lower region of the foot weight 50, a recess in the foot weight 50 is provided to create the space required between the foot weight 50 and the foot section 11.

Spacers 51 and 52 are provided between the foot weight 50 and the foot section 11 to reduce the formation of undesirable, specifically, sharply defined, shadows. These create a gap between the outer surface of the foot weight 50 and the inner surface of the foot section 11. As can be seen from the illustration, these spacers 51, 52 can be attached in different ways: on the one hand, an insertion into corresponding recesses of the foot weight 50 is possible; on the other hand, the spacers 51, 52 can also be embodied directly on the foot weight 50.

Finally, FIG. 8 once again shows an enlarged view to clarify the suspension of the pendulum 75. The aluminium profile 90 can be seen in the middle, which, as can be seen from the illustration, can be a standard profile, in particular, an extruded profile, in which grooves are embodied on all four longitudinal sides. In the exemplary embodiment shown, the grooves 88 and 89 embodied on the side serve to carry the weight 20 which is suspended from the aluminium profile 90 via a first arm 22 and a second arm 23. The first arm 22 and the second arm 23 are each L-shaped, wherein the shorter ends face each other and engage in the grooves 88 and 89, respectively. In the exemplary embodiment shown, the drive device, i.e. the motor 70, and the movement transmission elements: belt drive, continuous belt 97, drive wheel 95 and driven wheel 96, must overcome a frictional force towards the weight 20, so that the first arm 22 and the second arm 23 can slide in the groove 88 or 89 of the aluminium profile 90. Alternatively, to reduce friction, it can also be provided that the load transfer for the weight 20 is implemented using ball bearings.

It can also be seen in FIG. 8 that an upper run 97.1 and a lower run 97.2 of the continuous belt 97 extend in the grooves of the aluminium profile 90 which are directed towards the upper side or towards the lower side. The lower run 97.2 is rigidly connected to the weight 20 using a connecting element 21, so that the weight 20 follows a movement of the lower run 97.2 and thus ultimately of the continuous belt 97.

As already explained above, a retaining mount 72 is provided between the motor 70, which is not shown in FIG. 8, and the aluminium profile 90. This mount 72 is essentially U-shaped, wherein the orientation of the mount 72 is chosen so that the two legs of the U-shaped retaining mount engage around the aluminium profile 90. An articulated connection is embodied between the two legs of the U-shaped retaining mount 72 and the first leg 78 and the second leg 79 of the pendulum 75. In the simplest case, this can be achieved by providing bores in the U-shaped retaining mount 72 or, more precisely, in its legs, into which cylindrical ends of the first leg 78 and the second leg 79 of the pendulum 75 engage. Here, too, a bearing with reduced friction can be provided.

Conversely, it is also conceivable to provide pins on the legs of the U-shaped profile of the retaining mount g 72, which engage in corresponding recesses in the first leg 78 and the second leg 79, respectively.

1. A lighting device with adjustable inclination, comprising
a housing with a convex foot section and a shielding section connected thereto, and
a weight which is attached in the foot section with a variable position such that a centre of mass of the lighting device is variable, wherein a light source, which is configured for the purpose of light emission at least through the shielding section, can be arranged in the housing and wherein the inclination of the lighting device can be adjusted by changing a position of the weight within the foot section.

2. The lighting device according to claim 1, further comprising a foot weight arranged in a lower part of the foot section and rigidly connected thereto, which is configured to vary a position of the centre of mass of the lighting device in the direction of the longitudinal axis of the foot section.

3. The lighting device according to claim 2, wherein the foot weight is designed as an energy-storage device, and the foot section comprises a device for the inductive charging of the energy-storage device.

4. The lighting device according to claim 1, wherein the convex foot section is partially ellipsoidal, preferably semi-ellipsoidal and by particular preference hemispherical.

5. The lighting device according to claim 1, wherein the shielding section and the foot section can be connected in a manner releasable in several orientations, wherein the orientations differ in terms of an angle of rotation about an axis of rotation passing through a centre point of a base area of the shielding section.

6. The lighting device according to claim 5, wherein the orientations about the axis of rotation can be selected continuously, or wherein the orientations about the axis of rotation can be selected discontinuously and can preferably be selected at angular differences evenly spaced from one another about the axis of rotation.

7. The lighting device according to claim 1, wherein the shielding section and the foot section are each attached to a connecting ring, in the inner region of which a holder for the light source is arranged.

8. The lighting device according to claim 1, wherein the weight is mounted in a displaceable manner on a spindle mounted rotatably about a spindle axis on bearing points in the foot section.

9. The lighting device according to claim 8, wherein a longitudinal extension of the spindle defines an adjustment range within which the spindle is mounted in a displaceable manner, and the adjustment range is shorter than a distance between the bearing points.

10. The lighting device according to claim 8, wherein the spindle extends parallel to a main axis or a secondary axis of the partially ellipsoidal or semi-ellipsoidal foot section, in particular in the case of the hemispherical foot section, extending parallel to a diameter of the hemispherical foot section.

11. The lighting device according to claim 1, wherein a position of the weight can be adjusted by means of a drive device.

12. The lighting device according to claim 11, wherein, for the variation of position, the drive device cooperates via a belt drive, which is coupled to the weight, in such a manner that the weight performs a linear movement.

13. The lighting device according to claim 12, wherein a pendulum is suspended in a fixed position in the foot section, at the end of which facing away from the suspension an antenna is arranged for inductive energy transmission.

14. The lighting device according to claim 13, wherein the pendulum passes through a slot provided in the foot weight, and the antenna extends between the foot weight and the foot section.
